(19) United States
(12) Patent Application Publication
(10) Pub. No.: US 2016/0333826 A1
(43) Pub. Date: Nov. 17, 2016

(54) Post-Launch CO2 Gas Production System

(71) Applicant: Busek Co., Inc., Natick, MA (US)

(72) Inventors: Michael M. Tsay, North Chelmsford, MA (US); Michael Robin, Lincoln, RI (US); Kurt W. Hohman, Millis, MA (US)

(73) Assignee: Busek Co., Inc.

(21) Appl. No.: 15/138,508

(22) Filed: Apr. 26, 2016

Related U.S. Application Data
(60) Provisional application No. 62/160,331, filed on May 12, 2015.

(51) Int. Cl. F02K 9/50; F02K 9/62; F02K 9/60; C06B 47/12; C06B 47/08

(52) U.S. Cl. CPC F02K 9/50; C06B 47/12; C06B 47/08; F02K 9/605; F02K 9/62; F05D 2220/80; F05D 2260/20

(57) ABSTRACT

A post launch pressurized gas production system and method includes a cell containing a pressurized gas producing medium, such as anhydrous sodium bicarbonate producing CO₂ gas when heated. A plenum tank is in fluid communication with the cell. A heater heats the cell to produce gas delivered to the plenum tank storing the gas therein under pressure. A pressure vessel includes a propellant therein pressurized by the gas and in fluid communication with a thruster for delivery of the propellant to the thruster after pressurization by the gas.

### RELATED APPLICATION

This application claims benefit of and priority to U.S. Provisional Application Ser. No. 62/160,331 filed May 12, 2015, under 35 U.S.C. §§119, 120, 363, 365, and 37 C.F.R. §1.55 and §1.78, and which is incorporated herein by this reference.

### FIELD OF THE INVENTION

This application pertains to spacecraft gas production, utilization, and storage.

### BACKGROUND OF THE INVENTION

In space applications, a liquid propellant may be delivered under pressure to a thruster using a gas expulsion tank containing a gas under pressure. See, for example, U.S. Pat. No. 5,471,833 incorporated herein by this reference.

Such gas expulsion tanks can be heavy, occupy significant real estate, and can impose hazards to a launch since it can be dangerous to store and/or transport gasses at high pressures. If the propellant is pressurized before and during launch and leaks, the result can also be disastrous. Using a mechanical pump system to pressurize the propellant post launch requires power and can be prone to various failure modes.

Certain gasses can be generated post-launch. Some gasses, for example oxygen, can be generated by electrolysis. But, other dangerous gasses such as hydrogen in excess, for example, are also generated. Also, it is desirable that only inert gasses be used for certain subsystems such as for propellant pressurization. Moreover, the gas used for propellant pressurization must be at a sufficiently high pressure, for example 350 psi.

### BRIEF SUMMARY OF THE INVENTION

Aspects of the invention involve heating and thermally decomposing pure, anhydrous sodium bicarbonate powder for the production of CO₂ gas. Because the powder material is a solid, there is less concern with product gas separation in a zero gravity environment and material containment is greatly simplified with the use of a single frit. The low-vapor pressure and low-reactivity of sodium bicarbonate also provide great shelf-storability. The thermal decomposition process of anhydrous sodium bicarbonate is endothermic with no chance of a runaway reaction and the only gaseous byproducts are CO₂ and H₂O. The H₂O however does not stay in gaseous phase in the invented design due to high-pressure environment and optional thermally-insulated, cold transmission lines. The invented design also traps condensed-phase H₂O so to minimize CO₂ pressure loss due to carbonation of liquid H₂O. One test system has proven to generate zero gas at elevated storage temperature up to 75° C. and it does not generate significant gas until the cell reaches ˜110° C. Nominal operational temperature range (for active, high-speed gas production) is between 180 and 220° C. The reaction is stopped at the moment when electrical power is cut off from the heating element.

Featured is a post launch gas (e.g., CO₂) production system comprising a cell containing, for example, anhydrous sodium bicarbonate and a plenum tank in fluid communication with the cell. A heater is used to heat the anhydrous sodium bicarbonate to produce CO₂ gas delivered to the plenum tank storing the CO₂ gas therein under pressure. A pressure vessel includes a propellant therein pressurized by the CO₂ gas. Exemplary liquid propellants includes hydrazine, RP-1, methane, LOX, and non-toxic “green” monopropellants AF-M315E and LMP-103S. The pressure vessel is in fluid communication with a thruster for delivery of the propellant to the thruster after pressurization by the CO₂ gas. Different techniques may be used to prevent the CO₂ gas from losing pressure by a reaction with H₂O generated in the cell when heated: a check valve between the plenum tank and the cell and/or a filter between the plenum tank and the cell. A cooling device between the plenum tank and the cell can also be implemented to further ensure no steam ever contributes to the plenum tank pressure as all H₂O will be forced into a condensed phase.

Also featured is a method of pressurizing a propellant comprising heating a cell containing a solid medium to produce a gas, delivering the gas to a plenum tank and increasing the pressure of said gas in the plenum tank, using the pressurizing gas to pressurize a propellant, and delivering the pressurized propellant to a thruster. The method may further include the step of subjecting the solid medium to a vacuum and/or heat prior to loading the cell with a solid medium and removing any water vapor generated when the solid medium is subjected to a vacuum.

U.S. Pat. Nos. 2,816,419 and 3,733,180 as well as Keener et al, “Thermal Decomposition of Sodium Bicarbonate”, Chem. Eng. Commun. Vol. 33, pp 93-105 (1985) are incorporated herein by this reference.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a prior art propellant pressurization system;

FIG. 2 is a schematic diagram showing several of the primary components associated with a post launch gas production and utilization system in accordance with aspects of the invention;

FIG. 3 is a graph showing pressure and temperature over time for the CO₂ gas stored in the plenum tank of FIG. 2; and

FIG. 4 is a graph showing pressure and temperature over time of the CO₂ stored in the plenum tank during a step wise charging process.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

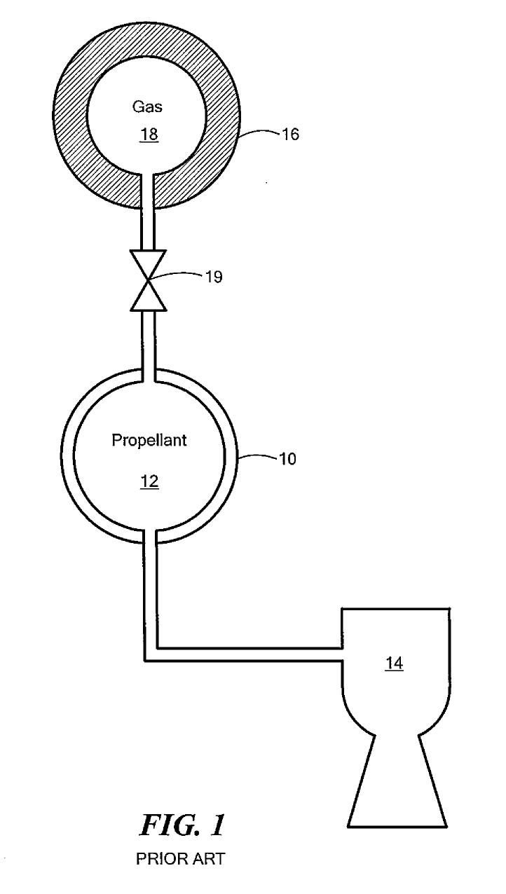

FIG. 1 shows a source 10 of propellant 12 delivered to thruster 14 via gas expulsion tank 16 containing pressurized gas 18 delivered to propellant 12 via valve 19. Such a system results in a heavy and fairly large tank 16. This source of pressurized gas can be dangerous during launch of a spacecraft employing thruster 14. In other prior art designs, the propellant is pressurized and similar inherent dangers exist.

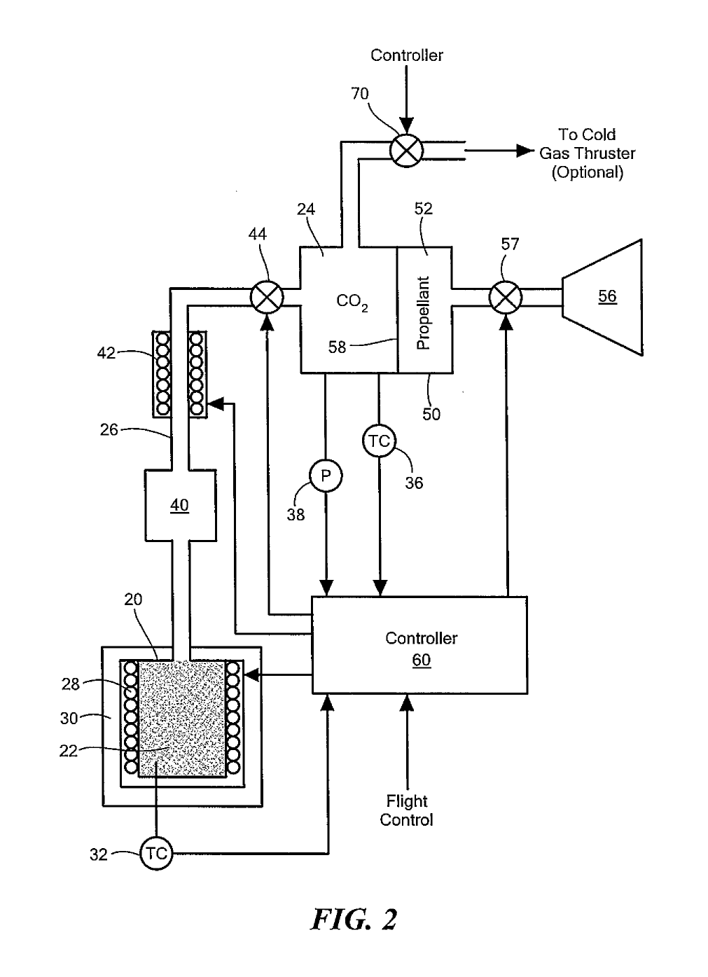

FIG. 2 shows an example of the invention for a monopropellant thruster application. The invention includes a stainless steel or titanium cell 20 containing anhydrous sodium bicarbonate 22 in powder form. Technical grade sodium bicarbonate was placed in a vacuum chamber and subjected to a vacuum of one Torr or less for twelve hours and any water vapor generated was pumped out of the vacuum chamber. The cell 20 was also heated in an oven to ensure no water was present. The resulting anhydrous sodium bicarbonate 22 was loaded into dry cell 20. Anhydrous sodium bicarbonate is preferred because its reaction temperature is more predictable and much higher than normal ambient temperatures.

Plenum tank 24 is in fluid communication with cell 20 as shown via stainless steel or titanium tubing 26. A heater such as electrical resistance heater 28 is configured to heat cell 20. The heater may be disposed outside of cell 20 as shown or inside the cell. Other heaters are possible. Insulation 30 may be provided. A temperature sensor such as thermocouple 32 may be included to monitor the temperature of the anhydrous sodium bicarbonate 22 in cell 20.

When the anhydrous sodium bicarbonate 22 is heated via heater 28, CO₂ gas is produced and delivered to plenum tank 24 via tubing 26 and the gas is pressurized in plenum tank 24. Pressure sensor 38 and/or temperature sensor 36 may be used to monitor the pressure and temperature of the CO₂ gas. Solid residues generated from the sodium bicarbonate thermal decomposition will stay in the cell 20. Water generated during the heating process is prevented from reaching plenum tank 24 using one or more techniques. Optional frit filter 40 may be used to trap any water vapor generated. The frit may be sintered stainless-steel or titanium powders or ceramic foams. A cooling device such as condenser 42 about the tubing 26 may be used to prevent water vapor from reaching plenum tank 24. In general, some means are used to trap or condense (using lower temperatures and/or pressures) any water vapor so it does not reach plenum tank 24. If water vapor does reach plenum tank 24, the plenum pressure will drop as due to the eventual condensation of water vapor at lower pressure or temperature. In addition, CO₂ gas will undesirably lose pressure by dissolving in the liquid water. Check valve 44 can be used to prevent the CO₂ from escaping the plenum tank 24 and backflowing into the cell 20.

Pressure vessel 50 (which may be separate from plenum tank 24 in some embodiments) stores propellant 52 therein. The pressurized CO₂ gas in plenum tank 24 is used to pressurize the propellant for delivery to thruster 56. A monopropellant thruster is shown here, but the same idea can be applied for a bipropellant thruster or an electric propulsion thruster like a Hall Effect thruster or a gridded ion thruster. The gas may be delivered to thruster 56 under the control of valve 57. Piston, bladder or bellows 58 may separate plenum tank 24 and pressure vessel 50 to pressurize propellant 52 using the pressurized CO₂. gas.

Controller 60 may be configured to execute computer instructions which control heater 28, condenser 42, and electrically controlled valve 57 based on inputs received from the flight control subsystem associated with a satellite or other spacecraft maneuvered by thruster 56. Controller 60 may also receive as input signals from temperature sensors 32 and 36, and pressure sensor 38 (and other possible inputs). Controller 60 may be a subsystem associated with the flight control subsystem and/or may be a separate microcontroller, application specific integrated circuit, field programmable gate array, or other processing means. Preferably, CO₂ gas is produced post launch/deployment of the satellite or other spacecraft.

In systems including one or more cold gas thrusters, pressurized CO₂ gas may be delivered to such thrusters as shown in FIG. 2 directly from plenum tank 24 via electrically controllable valve 70.

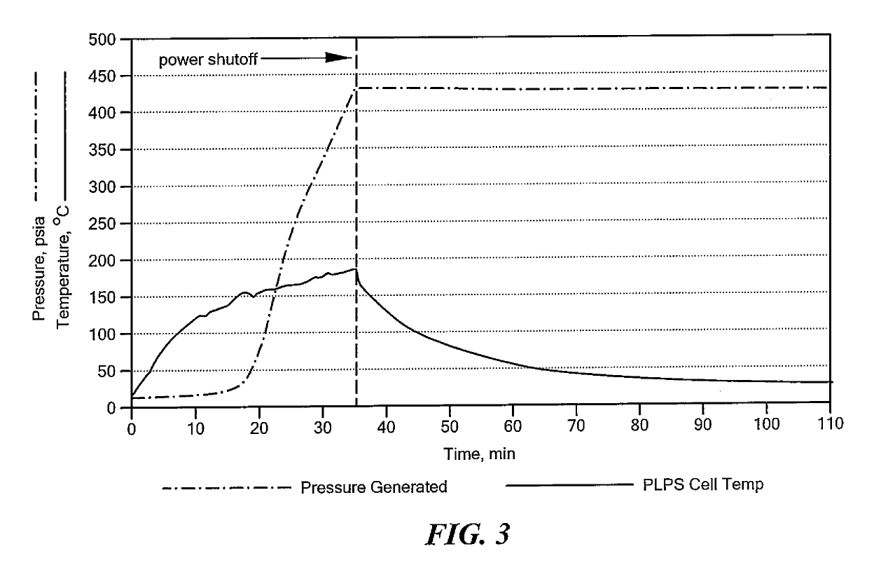

In a proof-of-concept test, where a small 25 cc cell containing 35 g of technical-grade sodium bicarbonate powder was heated to produce 400 psi of CO₂ gas in a capped-off 60 cc plenum tank. The test setup included a frit filter to contain the sodium bicarbonate powders and a check valve was used to isolate the plenum pressure from the cell after powering off. As mentioned previously, although gaseous H₂O is a byproduct of the thermal reaction, it is believed that no gas-phase H₂O reached the plenum and the pressure reading was purely due to gaseous CO₂. See FIG. 3. Evidences for such claim come from 1) the plenum wall was at constant 25° C. (via thermocouple measurement) so if there was any H₂O presence it would have been in liquid phase and 2) after the cell was powered off and cooled down to room temperature, the plenum pressure did not decrease, indicating the pressure was caused by a cold gas that can only be CO₂.

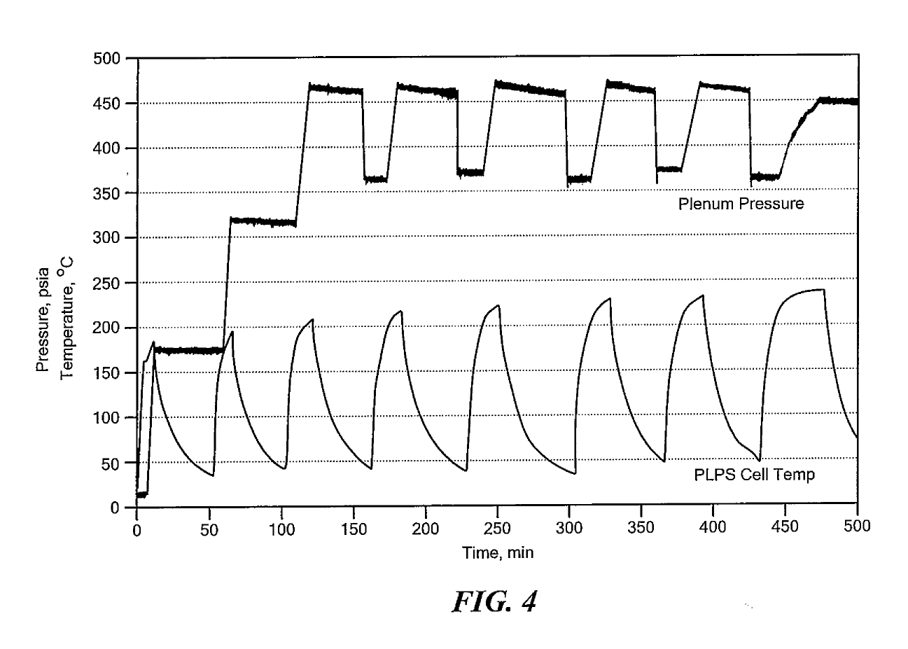

The invented system is stop/startable without losing any gas pressure. This is a unique feature that a small spacecraft can take advantage of if the onboard power system cannot supply the cell heater enough energy to generate the full pressure in a single battery charge. To demonstrate such stop/startable feature, an experiment was performed and the result is shown in FIG. 4. The step-wise gas generation initially produced 175 psia of plenum pressure before power was cut off from the cell. The pressure was held constant during cell cool-down, and this down-time simulates spacecraft bus battery recharging on orbit. After 40 minutes the cell was powered on again to fill the plenum to 320 psia. The cooling and charging were repeated again before the plenum reaching 465 psia. The second part of the test shown in FIG. 4 involved manually bleeding off 100 psi of pressure with a ball valve on the plenum tank to simulate tank blowdown while firing a chemical thruster, followed by charging it back to 465 psia via the same gas generation process. The bleed-and-recharge operation was repeated five times until the 35 g of sodium bicarbonate powder was completely decomposed (which was why the fifth charge only reached 450 psia).

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A post launch pressurized gas production system comprising:
a cell containing a pressurized gas producing medium;
a plenum tank in fluid communication with the cell;
a heater for heating the medium to produce gas delivered to the plenum tank storing the gas therein under pressure; and
a pressure vessel including a propellant therein pressurized by the gas and in fluid communication with a thruster for delivery of the propellant to the thruster after pressurization by the gas.

2. The system of claim 1 further including means for preventing the gas from losing pressure by a reaction with liquid generated when the cell is heated by the heater.

3. The system of claim 2 in which the means for preventing loss of gas pressure in the plenum include a check valve between the plenum tank and the cell, a filter between the plenum tank and the cell, and/or a cooling device between the plenum tank and the cell.

4. The system of claim 1 in which the medium is an anhydrous sodium bicarbonate producing CO2 gas.

5. The system of claim 1 in which the heater is disposed about the cell.

6. The system of claim 5 further including insulation about the cell.

7. The system of claim 1 in which the plenum tank and the pressure vessel are separated by a piston, bladder, or bellows.

8. The system of claim 1 further including a valve between the cell and the plenum tank.

9. The system of claim 1 further including a valve between the pressure vessel and the thruster.

10. The system of claim 1 further including a temperature sensor associated with the cell, a temperature sensor associated with the plenum tank, and/or a pressure sensor associated with the plenum tank.

11. A method of pressurizing a propellant the method comprising:
heating a cell containing a solid medium to produce a gas;
delivering the gas to a plenum tank and increasing the pressure of said gas in the plenum tank;
using the pressurizing gas to pressurize a propellant; and
delivering the pressurized propellant to a thruster.

12. The method of claim 11 further including the step of subjecting the solid medium to a vacuum and/or heat prior to loading the cell with a solid medium.

13. The method of claim 12 further including removing any water vapor generated when the solid medium is subjected to a vacuum.

14. The system of claim 11 in which the medium is an anhydrous sodium bicarbonate producing CO2 gas.

15. The method of claim 11 in which heating the cell includes energizing a heater disposed about the cell.

16. The method of claim 11 further including insulating the cell.

17. The method of claim 11 further including monitoring the temperature of the cell, monitoring the temperature of the plenum tank, and/or monitoring the pressure of the plenum tank.
